(19) United States
(12) Patent Application Publication
(10) Pub. No.: US 2026/0348417 A1
(43) Pub. Date: Nov. 5, 2026

(54) Doghouse Interface Features

(71) Applicant: Illinois Tool Works Inc., Glenview, IL (US)

(72) Inventors: Mark O. Lepper, Oak Park, IL (US); Jessica J. Young, Chippewa Falls, WI (US); Maria Deininger, Uffenheim (DE); Hendrik Bobach, Hemmersheim (DE)

(21) Appl. No.: 19/651,910

(22) Filed: Apr. 20, 2026

Related U.S. Application Data
(60) Provisional application No. 63/797,212, filed on Apr. 30, 2025.

(51) Int. Cl. F16B 21/08

(52) U.S. Cl. CPC F16B 21/08

(57) ABSTRACT

A fastening system includes a doghouse structure secured to a first component and a doghouse fastener configured to connect the first component to a second component. The doghouse structure defines a cavity formed between spaced engagement structures. Each engagement structure includes an interior channel facing the cavity and an exterior channel facing away from the cavity. The doghouse fastener includes a doghouse head and a fastener portion extending along a center axis. The doghouse head includes an outward-facing rail and an inward-facing rail that slide into the interior and exterior channels, respectively, during insertion of the doghouse head into the cavity. The rails and channels form an interlocking interface that allows sliding installation while resisting removal of the doghouse head during a pullout attempt.

### CROSS-REFERENCE

The present application claims priority to United States Provisional Patent Application No. 63/797,212, filed Apr. 30, 2025, and entitled “Doghouse Interface Features,” which is hereby incorporated by reference in its entirety.

### BACKGROUND

Automotive components require fastening techniques that are not only simple to manufacture and assemble but also highly reliable and efficient. Components must often be joined in a manner that is not only structurally sound but also cost-effective and suitable for high-volume manufacturing. Fasteners are commonly used to attach secondary panels, trim pieces, or brackets to primary structural panels. One type of fastener uses a doghouse structures to receive fasteners laterally; however, such doghouse structures can deform when subjected to an axial pull-out force. For example, the doghouse may flex or deform when components are pulled apart, allowing a fastener head to disengage and resulting in reduced retention strength. Accordingly, there is a need for fastening solutions that improve pull-out strength and reduce the likelihood of deformation in such structures. Therefore, there is a need for a fastener that enhances retention and pull-out resistance, particularly in deformable mounting features such as doghouses.

### SUMMARY

The present disclosure relates generally to a fastening system and fastener to form a connection between components, such as automotive panels, substantially as illustrated by and described in connection with at least one of the figures, as set forth more completely in the claims. More specifically, the present disclosure provides, in one example, a doghouse structure and a fastener with a doghouse head, each having improved interface features.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIGS. 1a and 1b illustrate perspective and side elevation assembly views, respectively, of an example fastening system configured to connect components in accordance with aspects of this disclosure.

FIG. 1c illustrates a perspective view of the fastening system in a partially assembled state.

FIG. 1d illustrates a first side elevation view of the partially assembled fastening system.

FIG. 1e illustrates a second side elevation view of the partially assembled fastening system.

FIG. 1f illustrates a side elevation view of the fastening system with the fastener separated from the doghouse structure.

FIG. 1g illustrates a first side elevation view of the fastening system with the fastener installed in the doghouse structure.

FIG. 1h illustrates a second side elevation view of the fastening system with the fastener installed in the doghouse structure.

FIG. 1i illustrates a side cross-sectional view taken along cutline A-A (FIG. 1e).

FIG. 1j illustrates a perspective cross-sectional view taken along cutline B-B (FIG. 1h).

FIG. 1k illustrates a perspective view of the fastening system with the fastener installed in the doghouse structure.

FIG. 2a illustrates a first perspective view of the fastener shown in FIGS. 1a through 1k, including a doghouse head.

FIG. 2b illustrates a second perspective view of the fastener.

FIG. 2c illustrates a first side elevation view of the fastener.

FIG. 2d illustrates a second side elevation view of the fastener.

FIG. 2e illustrates a top plan view of the fastener.

FIG. 2f illustrates a bottom plan view of the fastener.

FIG. 3a illustrates a first perspective cross-sectional view of the doghouse structure shown in FIGS. 1a through 1k, taken along cutline C-C (FIG. 1f).

FIG. 3b illustrates a second perspective cross-sectional view of the doghouse structure.

FIG. 3c illustrates a third perspective cross-sectional view of the doghouse structure.

FIG. 3d illustrates a fourth perspective cross-sectional view of the doghouse structure.

FIG. 3e illustrates a first side elevation view of the doghouse structure.

FIG. 3f illustrates a second side elevation view of the doghouse structure.

FIG. 3g illustrates a third side elevation view of the doghouse structure.

FIG. 3h illustrates a fourth side elevation view of the doghouse structure.

FIG. 4a illustrates a first perspective view of a fastener with a doghouse head in accordance with another aspect.

FIG. 4b illustrates a second perspective view of the fastener.

FIG. 4c illustrates a first perspective view of a corresponding doghouse structure.

FIG. 4d illustrates a second perspective view of the doghouse structure.

FIG. 4e illustrates a side elevation view of the doghouse structure.

FIG. 4f illustrates a top plan view of the doghouse structure.

FIG. 4g illustrates a side elevation view of an assembly of the fastener and doghouse structure.

FIG. 4h illustrates a cross-sectional view of the assembly.

FIG. 4i illustrates a finite element analysis (FEA) of the assembly during pullout extraction of the fastener.

FIG. 5a illustrates a first perspective view of another fastener with a doghouse head.

FIG. 5b illustrates a second perspective view of the fastener.

FIG. 5c illustrates a first perspective view of a corresponding doghouse structure.

FIG. 5d illustrates a second perspective view of the doghouse structure.

FIG. 5e illustrates a side elevation view of the doghouse structure.

FIG. 5f illustrates a top plan view of the doghouse structure.

FIG. 5g illustrates a side elevation view of an assembly of the fastener and doghouse structure.

FIG. 5h illustrates a cross-sectional view of the assembly.

FIG. 5i illustrates a FEA of the assembly during pullout extraction.

FIG. 6a illustrates a perspective assembly view of another fastener with a doghouse head and associated doghouse structure.

FIG. 6b illustrates a side elevation view of the assembly.

FIG. 6c illustrates a cross-sectional view of the assembly.

FIG. 6d illustrates a FEA during pullout extraction.

FIG. 7a illustrates a perspective assembled view of a fastener with a doghouse head and associated doghouse structure.

FIG. 7b illustrates a bottom plan view of the assembly.

FIG. 7c illustrates a perspective cross-sectional view taken along cutline D-D (FIG. 7b).

FIG. 7d illustrates a perspective cross-sectional view taken along cutline E-E (FIG. 7b).

FIG. 7e illustrates a bottom plan view taken along cutline F-F (FIG. 7a).

FIG. 7f illustrates a perspective cross-sectional view taken along cutline F-F (FIG. 7a).

FIG. 8a illustrates a perspective assembly view of another fastener with a doghouse head and associated doghouse structure.

FIG. 8b illustrates a perspective assembled view of the fastening system.

FIG. 8c illustrates a bottom perspective view of the fastener.

FIG. 8d illustrates a top perspective view of the doghouse structure.

FIG. 8e illustrates a perspective cross-sectional view taken along cutline G-G (FIG. 8b).

FIG. 8f illustrates a perspective cross-sectional view taken along cutline H-H (FIG. 8b).

FIGS. 9a through 9g illustrate additional fastener configurations for coupling with a component in accordance with further aspects of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A fastener can be used to form a connection between a first component and a second component, such as automotive panels. The disclosed fastener provides a fastener with a doghouse head and doghouse structure with improved retention features.

In one example, a fastening system comprises: a doghouse structure associated with a first component, the doghouse structure defining a cavity and a pair of spaced-apart engagement structures, each engagement structure defining an interior channel facing the cavity; and a doghouse fastener comprising a doghouse head and a fastener portion extending along a center axis, wherein the doghouse head includes an outward-facing rail configured to be received within and translate along the interior channel during insertion of the doghouse head into the cavity along an insertion direction, and wherein the outward-facing rail and the interior channel cooperatively define an interface that permits insertion of the doghouse head via sliding motion while resisting removal of the doghouse head from the cavity in a direction parallel to the center axis.

In some examples, the interface defined by the outward-facing rail and the interior channel includes overlapping portions.

In some examples, the outward-facing rail and the interior channel include at least one of a hook-shaped or an L-shaped sloped interfacing surfaces.

In some examples, the outward-facing rail and the interior channel define substantially flat, angled surfaces.

In some examples, the interface is configured such that a first force is required to insert the doghouse head into the cavity and a greater second force is required to remove the doghouse head from the cavity.

In some examples, the doghouse structure further comprises at least one structural rib extending between at least one of the pair of spaced-apart engagement structures and the first component.

In some examples, the doghouse structure further comprises at least one clip having a ramped surface configured to permit insertion of the doghouse head and a reverse-facing surface configured to resist removal of the doghouse head.

In some examples, the doghouse structure further comprises a recess and the fastener portion includes a protrusion configured to be received within the recess to form a detent engagement.

In some examples, the detent engagement is configured to provide at least one of audible or tactile feedback upon full insertion of the doghouse fastener into the doghouse structure.

In some examples, the detent engagement inhibits movement of the doghouse fastener relative to the doghouse structure.

In some examples, the outward-facing rail is positioned at an end of the doghouse head and oriented away from the doghouse structure.

In some examples, the fastener portion includes a stem and at least one resilient wing configured to engage an opening in a second component.

In another example, a doghouse structure associated with a component comprises: a body defining a cavity; and a pair of spaced-apart engagement structures defining the cavity, each engagement structure including an interior channel facing the cavity, wherein the interior channel is configured to receive an outward-facing rail of a mating fastener such that relative sliding insertion is permitted and removal along a central axis is resisted by an engagement between the interior channel and the outward-facing rail.

In some examples, the interior channel includes at least one of a hook-shaped or an L-shaped profiles.

In some examples, the interior channel includes a substantially flat, angled surface configured to form a ramped interface with the outward-facing rail.

In some examples, the doghouse structure further comprises a recess formed in at least one of the engagement structures, the recess configured to receive a protrusion of a mating fastener to form a detent engagement.

In some examples, the doghouse structure further comprises at least one structural rib coupled between at least one engagement structure and the component.

In some examples, the doghouse structure further comprises at least one resilient clip configured to engage a mating fastener to resist withdrawal.

In another example, a doghouse fastener comprises: a doghouse head; and a fastener portion extending from the doghouse head along a center axis, wherein the doghouse head includes an outward-facing rail configured to slidingly engage a corresponding interior channel of a doghouse structure during insertion, and wherein the outward-facing rail is shaped to cooperate with the interior channel to resist removal of the doghouse head along the center axis.

In some examples, the outward-facing rail includes at least one of a hook-shaped or an L-shaped sloped profile.

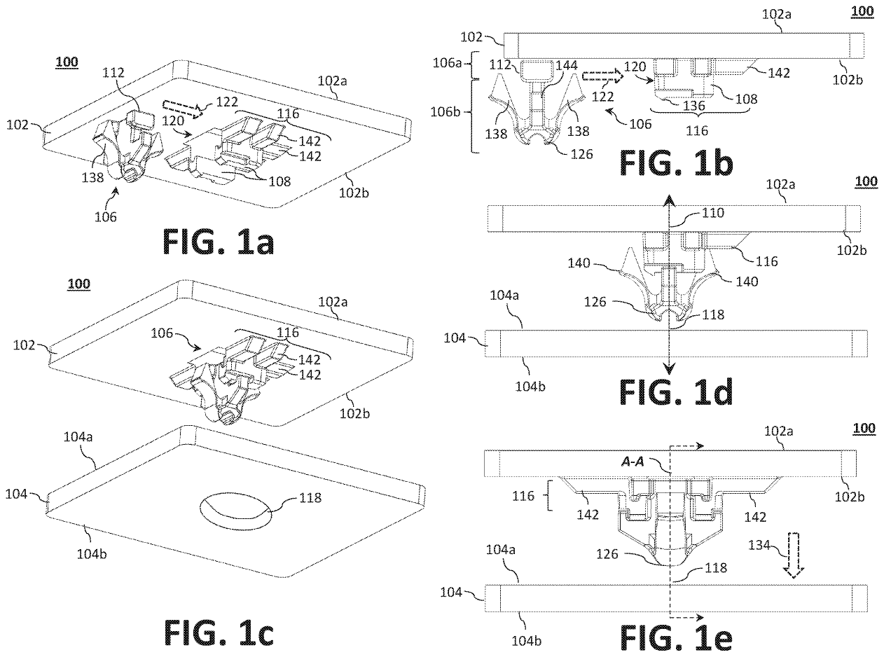

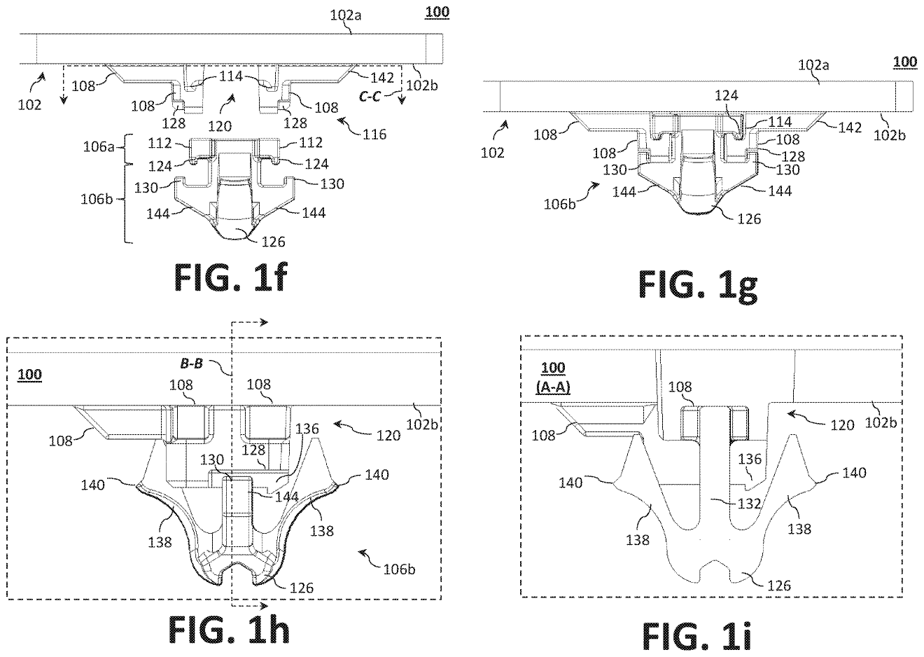

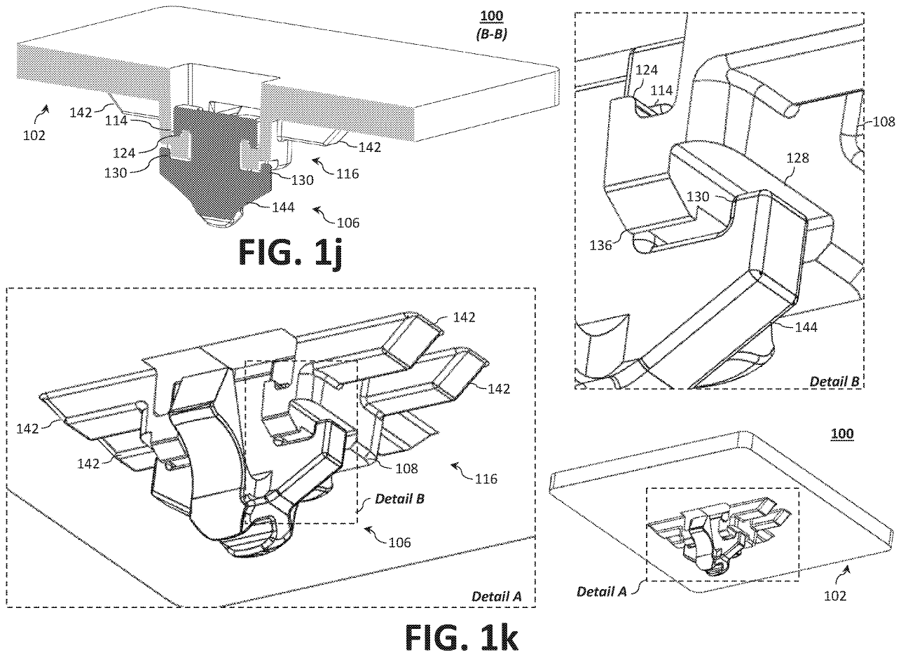

FIGS. 1a and 1b illustrate perspective and side elevation assembly views, respectively, of an example fastening system 100 configured to connect a first component 102 and a second component 104. FIGS. 1c through 1e illustrate perspective and side elevation views of the fastening system 100 in a partially assembled condition in which a doghouse fastener 106 is installed within a doghouse structure 116 of the first component 102, but is not yet coupled with the second component 104. FIG. 1f illustrates a side elevation view of the doghouse fastener 106 separated from the doghouse structure 116. FIGS. 1g and 1h illustrate side elevation views with the doghouse fastener 106 installed within the doghouse structure 116. FIG. 1i illustrates a cross-sectional view taken along cutline A-A of FIG. 1e, and FIG. 1j illustrates a perspective cross-sectional view taken along cutline B-B of FIG. 1h. FIG. 1k illustrates a perspective view of the fastening system 100 with the doghouse fastener 106 installed within the doghouse structure 116.

The first component 102 and the second component 104 may be any suitable structural or semi-structural members. By way of non-limiting example, the first component 102 and the second component 104 may be panels, trim components, moldings, or other substrates used in interior or exterior applications. The first component 102 and the second component 104 may be formed from metals or metal alloys, polymeric materials (including thermoplastics such as acrylonitrile butadiene styrene (ABS) and polyvinyl chloride (PVC)), composite materials (e.g., fiberglass-reinforced materials), or combinations thereof. Material selection for the first component 102 and the second component 104 may be based on desired stiffness, flexibility, manufacturability, environmental resistance, or other performance considerations.

The first component 102 may define an A-surface 102a and a B-surface 102b. The A-surface 102a is generally intended to be visible in a final assembled condition and may include aesthetic features such as texturing, coatings, or decorative finishes, and is generally free of attachment features. The B-surface 102b is generally concealed after assembly and may include structural or attachment features. In the illustrated configuration, the doghouse structure 116 extends from or is otherwise coupled to the B-surface 102b of the first component 102. The second component 104 may similarly define an A-surface 104a and a B-surface 104b and includes an opening 118 configured to receive at least a portion of the doghouse fastener 106. In an assembled condition, at least a portion of the second component 104 is covered by the first component 102.

The doghouse structure 116 may be integrally formed with the first component 102, for example via molding, or may be separately formed and subsequently attached to the first component 102 using adhesive bonding, welding, or mechanical fastening. While a single doghouse structure 116 is illustrated, a plurality of doghouse structures 116 may be distributed across the first component 102 to provide multiple attachment points.

The doghouse fastener 106 is a generally rigid component that defines a doghouse head 106a and a fastener portion 106b extending along a center axis 110. The doghouse head 106a and the fastener portion 106b may be integrally formed as a single piece, although multi-piece constructions are also contemplated.

The doghouse head 106a is configured to be received within a cavity 120 defined by the doghouse structure 116. The cavity 120 is at least partially defined by a pair of spaced-apart engagement structures 108 that extend from the first component 102. In some configurations, the cavity 120 may further be bounded by a bottom wall, a back wall, or other enclosing features. In some examples, one or more of the engagement structures 108 may be reinforced by structural ribs 142 extending between the engagement structures 108 and the first component 102. Such structural ribs 142 can be used to increase stiffness, particularly in instances where the first component 102 is formed from relatively compliant materials, thereby improving retention performance. The structural ribs 142 may follow contours of the first component 102 or may be otherwise shaped to accommodate packaging or structural constraints.

The doghouse head 106a is insertable into the cavity 120 via a generally linear sliding motion along the first component 102 in a direction indicated by arrow 122. The pair of spaced-apart engagement structures 108 can define features that guide and constrain this motion. The spaced-apart engagement structures 108 are illustrated as symmetrical, but asymmetrical version are contemplated (e.g., where it is desirable to limit insertion of the doghouse head 106a into the cavity 120 to a specific orientation). In the illustrated example, each engagement structure 108 defines an interior channel 114 facing toward the first component 102 (i.e., toward the cavity 120) and an exterior channel 128 facing away from the first component 102 (i.e., away from the cavity 120). The interior channel 114 and the exterior channel 128 may be formed on opposite sides of a common portion of each engagement structure 108. In the illustrated example, the common portion is illustrated as the portion of the engagement structures 108 that extends generally parallel to the first component 102. While both an interior channel 114 and an exterior channel 128 are illustrated, it is contemplated that one of the interior channel 114 and the exterior channel 128 can be omitted based on design needs or constraints (e.g., cost, weight, size, etc.).

The doghouse head 106a includes corresponding rail features configured to cooperate with the interior channel 114 and the exterior channel 128. Specifically, the doghouse head 106a is illustrated as generally bar-shaped with distal engagement ends 112 (e.g., blocks), each of which includes an outward-facing rail 124. The doghouse fastener 106 further comprises an inward-facing rail 130, which may be formed on fins 144 extending radially from a stem 132. Either the outward-facing rail 124 or the inward-facing rail 130 can be omitted depending on the design of the engagement structures 108 (i.e., whether one or both channels are provided via the engagement structures 108).

The outward-facing rail 124 is oriented to face away from the first component 102 (during assembly or when assembled) and is configured to be received within and translate along the interior channel 114. The inward-facing rail 130 is oriented toward the first component 102 (during assembly or when assembled) and is configured to be received within and translate along the exterior channel 128. The outward-facing rail 124 and the interior channel 114 are complementary, and the inward-facing rail 130 and the exterior channel 128 are complementary, such that the outward-facing rail 124 slides (or otherwise translates) within the interior channel 114 while the inward-facing rail 130 slides within the exterior channel 128 during insertion of the doghouse head 106a into the cavity 120.

The interface defined between the outward-facing rail 124 and the interior channel 114, and between the inward-facing rail 130 and the exterior channel 128, can provide both guidance during insertion of the doghouse head 106a and resistance to axial removal (i.e., pullout). In particular, the outward-facing rail 124 and the interior channel 114, and the inward-facing rail 130 and the exterior channel 128, may include overlapping or interlocking geometries that resist relative movement in a direction parallel to the center axis 110 and opposite the insertion direction (e.g., corresponding to arrows 134, 402). Absent such overlapping or interlocking geometries, the doghouse structure 116 can flex under stress (i.e., the engagement structures 108 could flex away from one another) to more easily release the doghouse head 106a axially.

In the illustrated configuration (e.g., as shown in FIG. 1j), the outward-facing rail 124, the inward-facing rail 130, the interior channel 114, and the exterior channel 128 include generally L-shaped or hook-shaped profiles such that portions of the outward-facing rail 124 extend behind corresponding portions of the interior channel 114, and portions of the inward-facing rail 130 extend behind corresponding portions of the exterior channel 128. This overlapping relationship creates a mechanical interlock that inhibits separation of the doghouse head 106a from the doghouse structure 116 in the axial direction along the center axis 110, for example, in the event the doghouse structure 116 flexes under axial pull.

The interface defined by the outward-facing rail 124 and the interior channel 114, and by the inward-facing rail 130 and the exterior channel 128, may be configured in a variety of geometries. In some examples, interfacing surfaces of the outward-facing rail 124 and the interior channel 114, and interfacing surfaces of the inward-facing rail 130 and the exterior channel 128, may be substantially orthogonal to define a hook-shaped engagement (as illustrated). In other examples, the interfacing surfaces of the outward-facing rail 124 and the interior channel 114, and the interfacing surfaces of the inward-facing rail 130 and the exterior channel 128, may be angled, sloped, curved, stepped, or otherwise contoured to provide a camming, wedging, or ramped interaction. For example, as will be described in connection with other examples, the outward-facing rail 124 and the interior channel 114, and the inward-facing rail 130 and the exterior channel 128, may include ramped or sloped surfaces that permit insertion of the doghouse head 106a under a first set of force conditions while increasing resistance to movement of the doghouse head 106a in a direction opposite the insertion direction along the center axis 110. The degree of overlap between the outward-facing rail 124 and the interior channel 114, and between the inward-facing rail 130 and the exterior channel 128, the angle of engagement surfaces, and the relative dimensions may be selected to achieve a desired balance between size, material usage, insertion force, and/or retention force. Variations may include, without limitation, ramped interfaces, dovetail-like geometries, compound curves, stepped interfaces, or multi-stage engagement profiles, each of which permits sliding installation while inhibiting unintended withdrawal of the doghouse head 106a along the center axis 110.

In addition to resisting axial pullout, the engagement between the outward-facing rail 124 and the interior channel 114, and between the inward-facing rail 130 and the exterior channel 128, increases the number and distribution of contact regions between the doghouse fastener 106 and the doghouse structure 116. This increased contact may reduce lateral movement or wobble between the doghouse fastener 106 and the doghouse structure 116 and may improve overall assembly robustness.

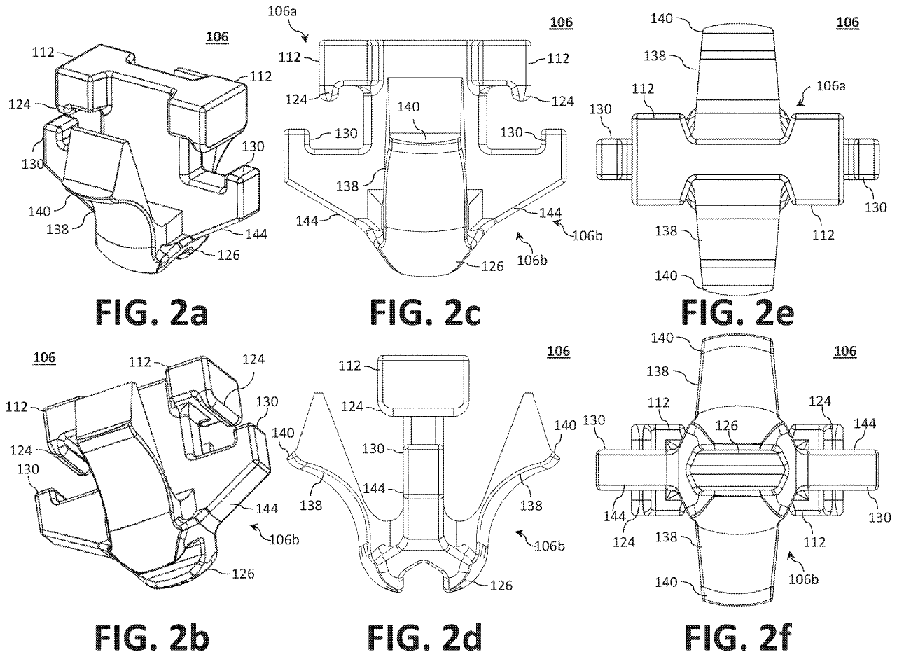

The outward-facing rail 124 may be positioned at opposed ends of the doghouse head 106a and oriented to face away from the doghouse structure 116 (during and post-assembly), while the inward-facing rail 130 may be formed on fins 144 extending radially from a stem 132 of the fastener portion 106b and oriented to face toward the doghouse structure 116 (during and post-assembly). In the illustrated example, there are two fins 144 oriented in opposite directions (offset by 180 degrees about the center axis 110). The fins 144 may have a generally triangular or tapered profile (when viewed from the side, as illustrated in FIG. 2c, for example), with the inward-facing rail 130 positioned at a distal region or end of each fin 144. Other geometries for supporting the inward-facing rail 130 are also contemplated, including curved, stepped, or multi-faceted projections.

The interior channel 114 is formed along an inner-facing surface of each engagement structure 108 and is oriented to face the cavity 120 and to receive the outward-facing rail 124 in a sliding manner. The exterior channel 128 is formed along an outer-facing surface of each engagement structure 108 opposite the interior channel 114 and is oriented to face away from the cavity 120 to receive the inward-facing rail 130 in a sliding manner. The relative positioning of the interior channel 114 and the exterior channel 128 with respect to the outward-facing rail 124 and the inward-facing rail 130 results in a crossed engagement in which the outward-facing rail 124 engages the interior channel 114 and the inward-facing rail 130 engages the exterior channel 128.

Retention of the doghouse head 106a within the cavity 120 may be further enhanced by one or more clips 136 formed in or on the engagement structures 108. Each clip 136 may include a ramped or sloped lead-in surface configured to permit the doghouse head 106a to pass during insertion along the direction indicated by arrow 122, and a reverse-facing surface (e.g., a flat 90-degree surface) configured to resist movement of the doghouse head 106a in a direction opposite the insertion direction (e.g., opposite arrow 122). The clip 136 may be resiliently deformable such that the clip 136 and/or the doghouse head 106a flexes under a threshold force to permit intentional removal of the doghouse fastener 106 from the doghouse structure 116.

Additional alignment features may be incorporated to facilitate positioning of the doghouse head 106a relative to the cavity 120 during insertion. Such alignment features may include auxiliary channels, auxiliary rails, chamfers, lead-in surfaces, or other guiding structures formed on the doghouse head 106a and/or the doghouse structure 116, and may correspond in function to the interior channel 114, the exterior channel 128, the outward-facing rail 124, and the inward-facing rail 130.

Once the doghouse head 106a is secured within the doghouse structure 116, the fastener portion 106b may be engaged with the second component 104 by insertion through the opening 118 along a direction indicated by arrow 134. The opening 118 may have any suitable geometry, including circular, quadrilateral (e.g., square or rectangular), or slotted configurations, and may be sized to receive the fastener portion 106b with an interference fit, snap-fit, or other engagement.

The fastener portion 106b may include the stem 132 and one or more resilient wings 138 extending from a distal end of the stem 132. The resilient wings 138 may define a lead-in nose 126 that is tapered to facilitate insertion into the opening 118. Each resilient wing 138 may further include a ledge 140 configured to engage an edge of the opening 118 to retain the fastener portion 106b relative to the second component 104.

A seal may be provided on the doghouse fastener 106, for example positioned between the doghouse head 106a and the fastener portion 106b. The seal may be annular and formed from foam, elastomeric material, thermoplastic material, or other compliant materials, and may be overmolded onto or otherwise attached to the doghouse fastener 106. The seal may be configured to mitigate ingress of contaminants such as dust, moisture, or debris through the opening 118 and may additionally reduce noise or vibration between the first component 102 and the second component 104. Additional features, such as ribs or wings, may also be included to reduce noise and/or rattle.

The doghouse fastener 106 may be manufactured using injection molding or other forming processes. Additive manufacturing techniques are also contemplated, including fused deposition modeling, stereolithography, selective laser sintering, material jetting, binder jetting, powder bed fusion, directed energy deposition, and vat photopolymerization. Such additive manufacturing techniques may enable formation of complex geometries associated with the outward-facing rail 124, the inward-facing rail 130, the interior channel 114, and the exterior channel 128, including undercuts and multi-directional features. Manufacturing resolution in both planar and vertical directions may influence feature fidelity, and different portions of the fastening system 100 may be produced at different resolutions to achieve desired performance characteristics.

The fastening system 100 thus provides a multi-stage engagement in which the doghouse head 106a is secured to the first component 102 via an interlocking interface defined by the outward-facing rail 124, the inward-facing rail 130, the interior channel 114, and the exterior channel 128, and the fastener portion 106b is subsequently secured to the second component 104. The interlocking interface defined by the outward-facing rail 124, the inward-facing rail 130, the interior channel 114, and the exterior channel 128 permits insertion of the doghouse head 106a via sliding motion while inhibiting removal of the doghouse head 106a along the center axis 110, thereby enhancing retention performance under applied loads while accommodating a range of geometrical variations consistent with the described interaction.

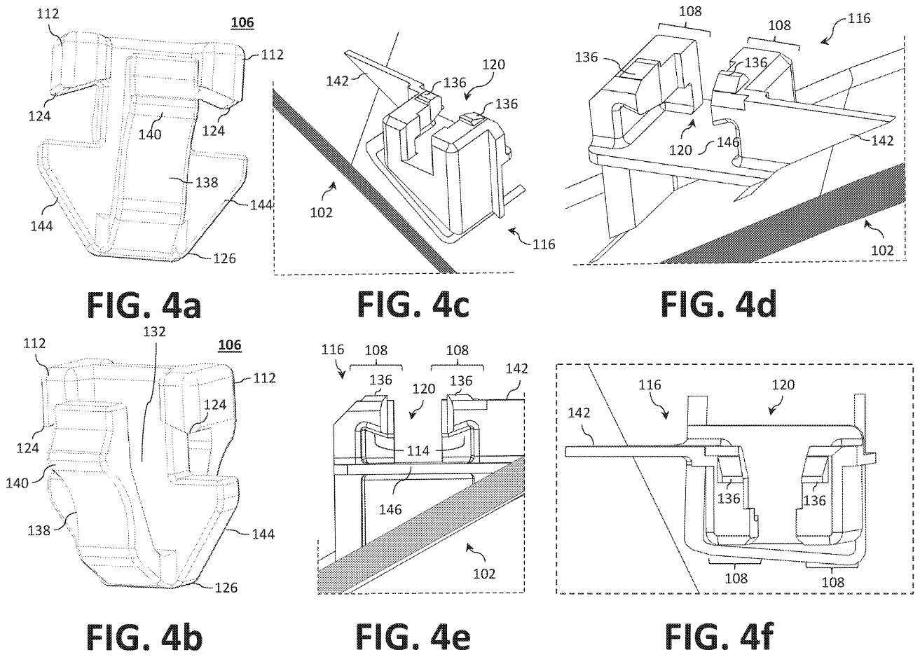

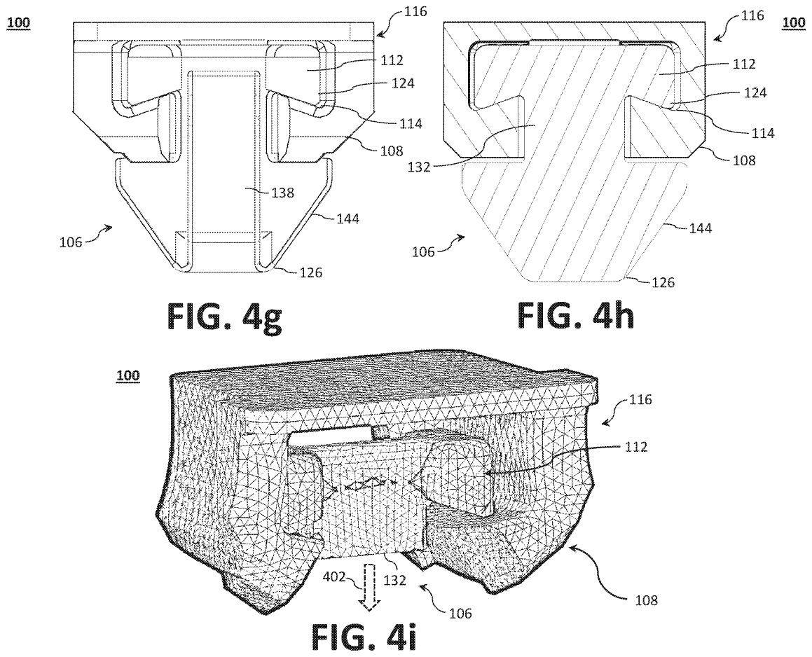

FIGS. 4a and 4b illustrate first and second perspective views, respectively, of a doghouse fastener 106 with a doghouse head 106a in accordance with another aspect. FIGS. 4c and 4d illustrate first and second perspective views, respectively, of a corresponding doghouse structure 116. FIGS. 4e and 4f illustrate side elevation and top plan views, respectively, of the doghouse structure 116. FIGS. 4g and 4h illustrate side elevation and cross-sectional views, respectively, of an assembly of the doghouse fastener 106 and doghouse structure 116. FIG. 4i illustrates a finite element analysis (FEA) of the assembly during pullout extraction of the fastener.

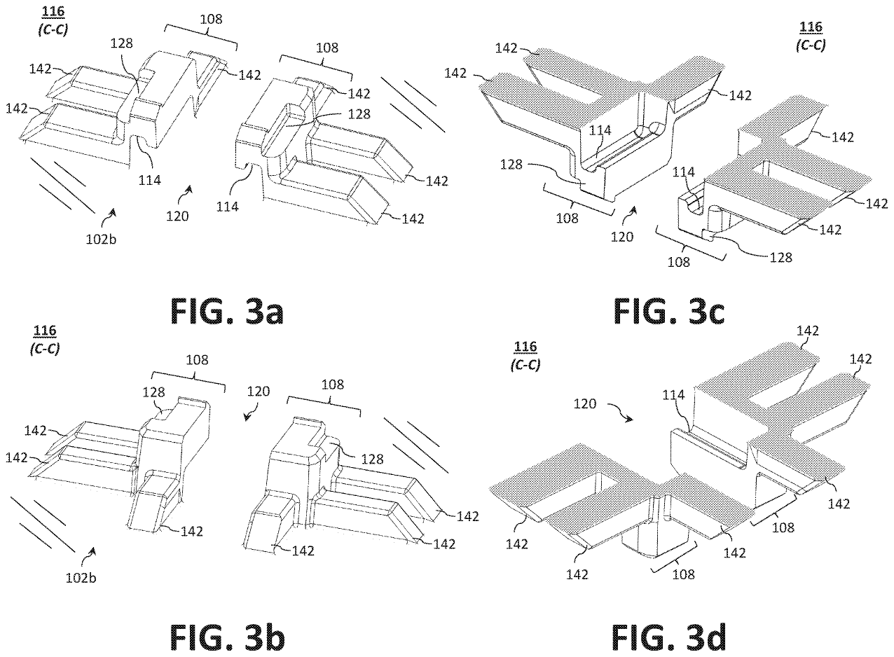

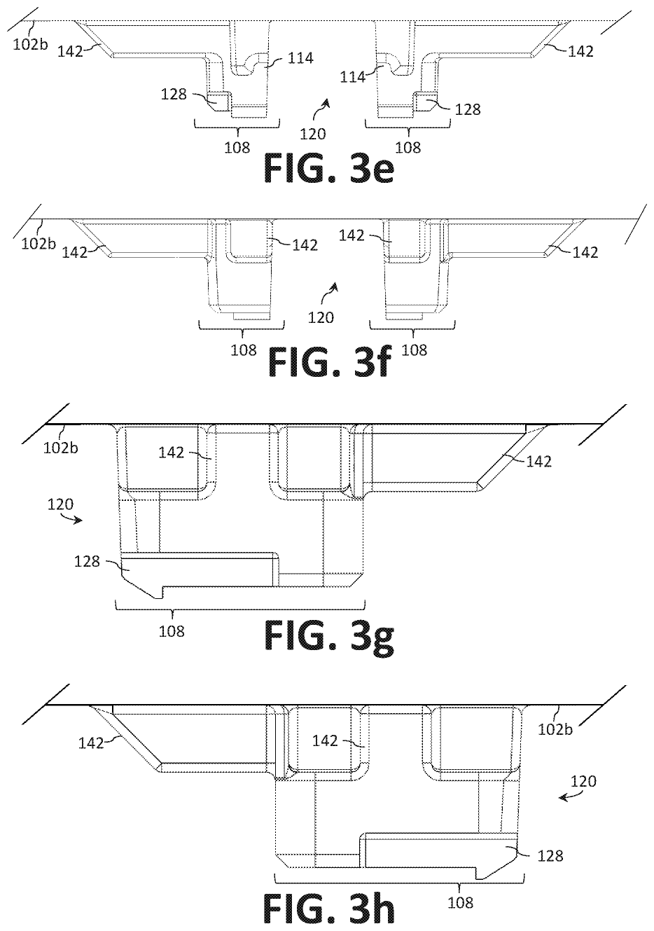

In this example, the overall fastening architecture is substantially similar to that described with respect to the examples of FIGS. 1a through 1k, 2a through 2f, and 3a through 3h; however, the engagement interface between the doghouse fastener 106 and the doghouse structure 116 is simplified. In particular, the exterior channel 128 and the inward-facing rail 130 are omitted, such that retention of the doghouse head 106a within the cavity 120 is achieved primarily through interaction between the outward-facing rail 124 and the interior channel 114. This configuration reduces geometric complexity while maintaining guided insertion and pullout resistance.

The doghouse structure 116 likewise includes a pair of spaced-apart engagement structures 108 that define the cavity 120, with each engagement structure 108 including an interior channel 114 oriented toward the cavity 120. In contrast to the prior example, the interior channel 114 does not form a hook-shaped or L-shaped undercut feature. Instead, the interior channel 114 is defined by a substantially flat, angled bearing surface (e.g., a wedge shape) configured to cooperate with a complementary outward-facing rail 124 of the doghouse head 106a. The angled surfaces may be oriented at an angle relative to a floor surface 146 of the cavity 120 (which may be part of the first component 102), for example within a range of about 30 to about 60 degrees, or more specifically about 30 to about 45 degrees, thereby forming a ramped or camming interface rather than an interlocking hook geometry. With reference to FIG. 4i, such a wedge design can also help pull the engagement structures 108 together during axial loading.

The outward-facing rail 124 of the doghouse head 106a is correspondingly configured as a substantially flat, angled projection that slides along the interior channel 114 during insertion of the doghouse head 106a into the cavity 120 along the direction indicated by arrow 122. Upon full insertion, the angled surfaces establish a wedged interface that resists relative movement in a direction corresponding to arrows 134, 402), thereby providing axial retention through frictional and geometric interference.

Because the exterior channel 128, inward-facing rail 130, and associated cross-engagement features are omitted, the retention mechanism in this example relies primarily on the single-sided engagement between the outward-facing rail 124 and the interior channel 114. This simplified geometry reduces the number of undercuts and opposing engagement surfaces, thereby facilitating manufacturability, reducing material usage, and enabling easier demolding in molding processes. Despite this simplification, the angled ramp interface provides controlled insertion, guided alignment, and increased resistance to pullout under load.

In the assembled condition shown in FIGS. 4g and 4h, the outward-facing rail 124 remains seated within the interior channel 114 such that axial removal of the doghouse head 106a is resisted by both elastic deformation of the engagement structures 108 and the wedging interaction of the angled surfaces. Under pullout loading conditions (indicated using arrow 402), as illustrated in the FEA of FIG. 4i, stress is distributed along the ramped interface, and increased normal forces develop between the outward-facing rail 124 and the interior channel 114, thereby increasing frictional resistance and enhancing retention stability within the

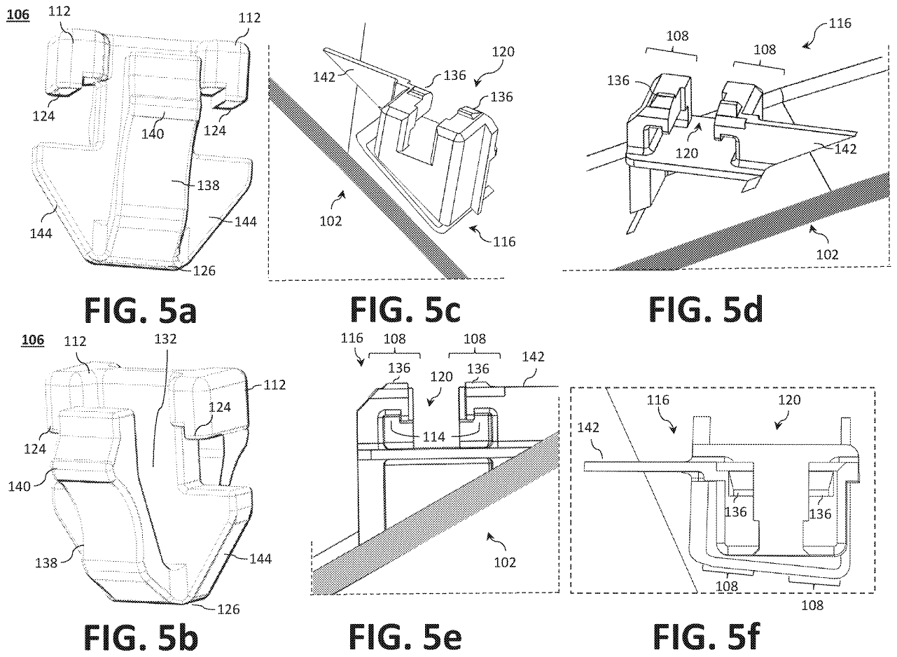

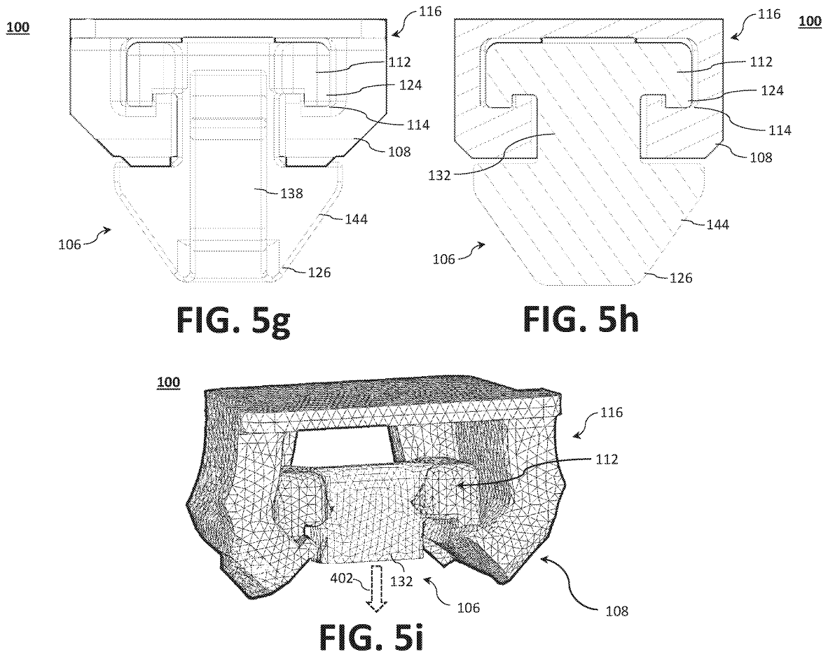

FIGS. 5a and 5b illustrate first and second perspective views, respectively, of another doghouse fastener 106 with a doghouse head 106a. FIGS. 5c and 5d illustrate first and second perspective views, respectively, of a corresponding doghouse structure 116. FIGS. 5e and 5f illustrate side elevation and top plan views, respectively, of the doghouse structure 116. FIGS. 5g and 5h illustrate side elevation and cross-sectional views, respectively, of an assembly of the doghouse fastener 106 and doghouse structure 116. FIG. 5i illustrates a FEA of the assembly during pullout extraction.

The doghouse structure 116 may be associated with a first component 102, and the doghouse fastener 106 may be configured to couple the first component 102 to a second component 104 in a manner similar to that described in connection with the prior examples. The doghouse structure 116 likewise defines a cavity 120 bounded at least in part by a pair of spaced-apart engagement structures 108 extending from a B-surface 102b of the first component 102. The second component 104 may include an opening 118 configured to receive a fastener portion 106b of the doghouse fastener 106 when the doghouse head 106a is installed within the cavity 120.

In this example, the engagement interface between the doghouse fastener 106 and the doghouse structure 116 is again simplified relative to certain of the previously-described configurations. In particular, the exterior channel 128 and the inward-facing rail 130 are omitted entirely (similarly to that of FIGS. 4a through 4i). As a result, the engagement between the doghouse fastener 106 and the doghouse structure 116 is defined primarily by interaction between an outward-facing rail 124 of the doghouse head 106a and an interior channel 114 formed on each of the engagement structures 108.

The doghouse head 106a is insertable into the cavity 120 via a generally linear sliding motion along a direction indicated by arrow 122. During insertion, the outward-facing rail 124 is received within and guided by the interior channel 114, which constrains lateral movement of the doghouse head 106a and facilitates alignment of the doghouse fastener 106 relative to the doghouse structure 116. In some examples, the engagement structures 108 may flex outwardly slightly during insertion to accommodate passage of the doghouse head 106a and may elastically return toward an initial position after the doghouse head 106a is fully seated within the cavity 120.

In the assembled condition shown in FIGS. 5g and 5h, the outward-facing rail 124 remains engaged within the interior channel 114, thereby resisting axial withdrawal of the doghouse head 106a from the cavity 120 in a direction opposite the insertion direction. Retention is achieved through a combination of mechanical interference, elastic deformation of the engagement structures 108, and frictional resistance along the interfacing surfaces of the outward-facing rail 124 and the interior channel 114. The interface may include overlapping surfaces similar to that of FIGS. 1a through 1k (hook-shaped or L-shaped profiles) that increase resistance to pullout while still permitting controlled insertion under an applied assembly force.

Because the exterior channel 128 and inward-facing rail 130 are omitted, the overall geometry of the doghouse structure 116 and doghouse head 106a is simplified, which may reduce tooling complexity and improve manufacturability while maintaining sufficient retention performance for the intended application.

Under pullout conditions, as illustrated in the FEA of FIG. 5i, stress is distributed primarily along the interface between the outward-facing rail 124 and the interior channel 114, with localized deformation occurring in the engagement structures 108 adjacent to the cavity 120. The resulting load path resists axial separation of the doghouse fastener 106 from the doghouse structure 116 while maintaining engagement under load.

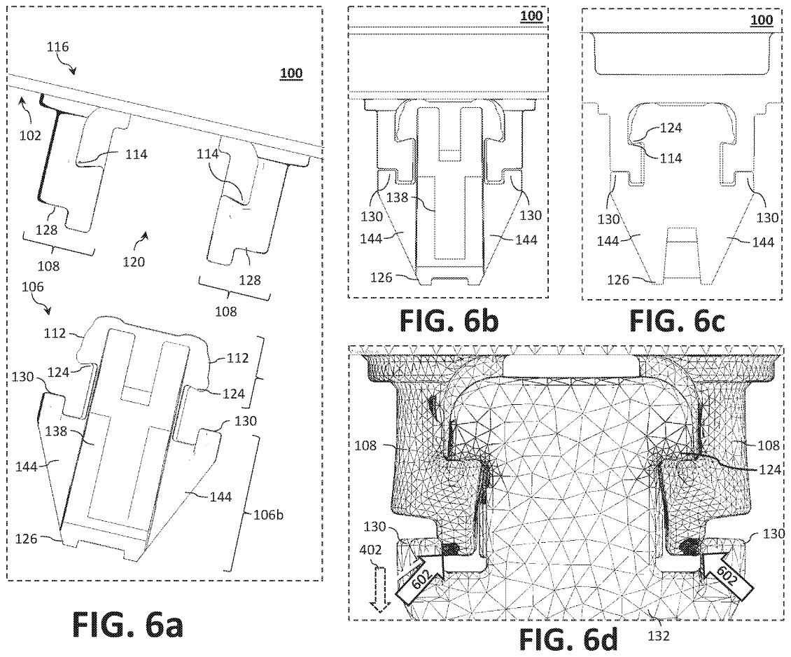

FIG. 6a illustrates a perspective assembly view of another doghouse fastener 106 with a doghouse head 106a and associated doghouse structure 116. FIGS. 6b and 6c illustrate side elevation and cross-sectional views, respectively, of the assembly, and FIG. 6d illustrates a FEA during pullout extraction.

As with the prior example, the doghouse structure 116 may be associated with a first component 102 and configured to receive the doghouse head 106a of the doghouse fastener 106 for coupling to a second component 104, for example in a manner similar to that described previously. The doghouse structure 116 defines a cavity 120 at least partially bounded by a pair of spaced-apart engagement structures 108 extending from a B-surface 102b of the first component 102. The second component 104 may include an opening 118 configured to receive a fastener portion 106b of the doghouse fastener 106 when the doghouse head 106a is installed within the cavity 120.

In this example, the fastening system 100 is further simplified relative to previously described configurations while maintaining a guided sliding insertion and pullout-resistant engagement. In particular, the outward-facing rail 124 and the interior channel 114 are each configured with substantially flat, angled engagement surfaces (wedges) rather than hook-shaped or L-shaped profiles.

The doghouse head 106a is insertable into the cavity 120 via a generally linear sliding motion along a direction indicated by arrow 122. During insertion, the outward-facing rail 124 engages the interior channel 114 in a ramped or camming manner, with interfacing surfaces oriented at an angle relative to the insertion direction, for example within a range of about 30 degrees to about 60 degrees, or more specifically about 30 degrees to about 45 degrees. This angled interface facilitates controlled insertion while generating a wedging action during a pull out condition.

Upon full insertion, the angled engagement between the outward-facing rail 124 and the interior channel 114 establishes a self-locking interface that resists movement of the doghouse head 106a in a direction of arrow 402. Retention is provided through a combination of elastic recovery of the engagement structures 108, normal forces generated by the ramped interface, and resulting frictional resistance along the contacting surfaces. Although simplified, the geometry maintains reliable axial retention by converting insertion forces into compressive engagement forces at the interface.

In the assembled condition shown in FIGS. 6b and 6c, the doghouse head 106a is seated within the cavity 120 with the outward-facing rail 124 retained within the interior channel 114. The simplified configuration reduces or eliminates undercut or interlocking hook geometries, thereby improving manufacturability and enabling easier demolding or forming while still providing controlled retention performance suitable for automotive or similar structural applications.

Under pullout loading conditions, as illustrated in the FEA of FIG. 6d, load transfer occurs primarily through the angled interface between the outward-facing rail 124 and the interior channel 114. As with the prior examples, the inward-facing rail 130 also engages the exterior channel 128 to mitigate separation of the engagement structures 108 during a pullout attempt (as indicated by arrows 602). Stress is distributed along the ramped contact surfaces, with increased normal forces developing as axial extraction is resisted.

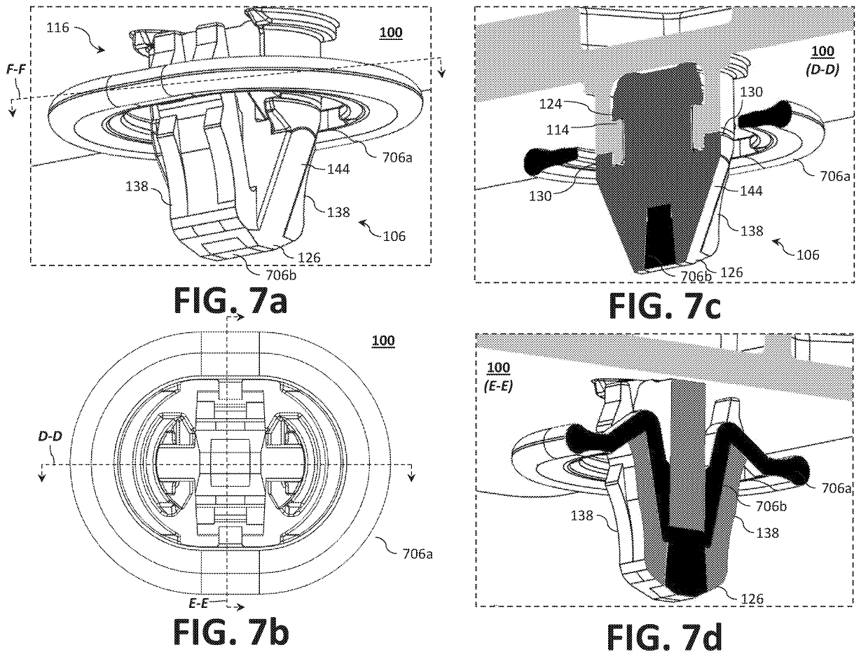

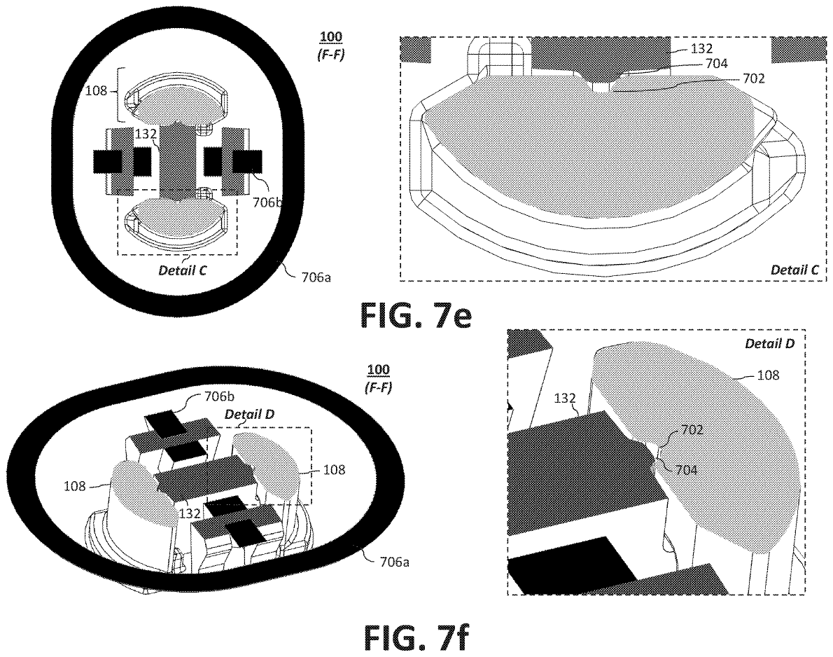

FIG. 7a illustrates a perspective assembled view of a doghouse fastener 106 with a doghouse head 106a and associated doghouse structure 116, and FIG. 7b illustrates a bottom plan view of the assembly. FIGS. 7c and 7d illustrate perspective cross-sectional views taken along cutlines D-D and E-E (FIG. 7b). FIGS. 7e and 7f illustrate bottom plan and perspective cross-sectional views, respectively, taken along cutline F-F (FIG. 7a).

In this example, the fastening system 100 further comprises a click-in knuckle feature configured to provide both tactile (haptic) and audible feedback upon full seating of the doghouse fastener 106 within the doghouse structure 116. This click-in knuckle feature also functions to limit lateral movement of the doghouse fastener 106 relative to the doghouse structure 116 (e.g., movement transverse to the center axis 110, such as left-right play).

The click-in knuckle feature includes a recess 702 formed in one or both of the engagement structures 108 and a corresponding protrusion 704 formed on the stem 132 of the fastener portion 106b. The recess 702 and protrusion 704 are positioned such that, during insertion of the doghouse head 106a into the cavity 120, the protrusion 704 is elastically urged past an edge of the engagement structure 108 until it aligns with and is received within the recess 702. Upon engagement, the protrusion 704 “clicks” into the recess 702 in a detent-like manner.

This detent engagement can produce a snap or click that provides assembly verification to an operator, indicating that the doghouse fastener 106 has reached a fully seated position within the doghouse structure 116. The engagement between the protrusion 704 and the recess 702 further inhibits relative movement between the doghouse fastener 106 and the doghouse structure 116 in directions transverse to the center axis 110, thus stabilizing the assembly and reducing potential rattle or misalignment.

In the assembled condition shown in FIGS. 7a through 7f, the doghouse head 106a is retained within the cavity 120 via the engagement between the outward-facing rails 124 and the interior channels 114, while the click-in knuckle feature defined by the recess 702 and protrusion 704 provides secondary retention and positional stability. Under service loads, including pullout forces applied along the center axis 110, the primary retention is maintained by the rail-channel interface, while the detent feature contributes to positional constraint and assembly confirmation.

In addition, and as shown in FIGS. 7a through 7f, the doghouse fastener 106 may further include an integral molded seal 706. The illustrated integral molded seal 706 includes a seal portion 706a and a body portion 706b that are integrally formed. The seal portion 706a (illustrated as a generally oval ring) is configured to engage and seal the opening 118, while the body portion 706b secures the seal portion 706a to the doghouse fastener 106. In the illustrated example, the body portion 706b is generally V-shaped (as shown in FIG. 7d) and extends around an end of the stem 132 of the fastener portion 106b and/or through gaps or channels defined through and/or between the stem 132 and the resilient wings 138 coupled to the stem 132 at the lead-in nose 126.

The integral molded seal 706 may be formed from foam, elastomeric material, thermoplastic material, or other compliant materials, and may be overmolded onto or otherwise attached to the doghouse fastener 106. The seal portion 706a is configured to mitigate ingress of contaminants such as dust, moisture, or debris through the opening 118, and may additionally reduce noise and/or vibration between the first component 102 and the second component 104. In some examples, additional features such as ribs, lips, or wings may be provided to further enhance sealing performance and/or reduce rattle.

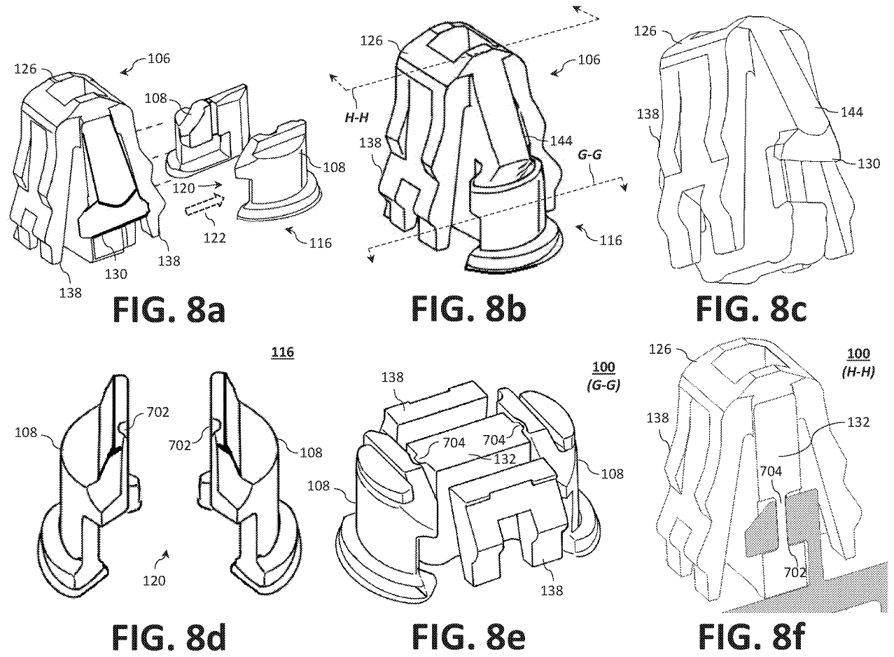

FIGS. 8a and 8b illustrate perspective assembly and assembled views, respectively, of another doghouse fastener 106 with a doghouse head 106a and associated doghouse structure 116. FIG. 8c illustrates a bottom perspective view of the fastener, and FIG. 8d illustrates a top perspective view of the doghouse structure 116. FIGS. 8e and 8f illustrate perspective cross-sectional views taken along cutlines G-G and H-H (FIG. 8b).

Similar to the configuration described with respect to FIGS. 7a through 7f, the fastening system 100 includes a click-in knuckle feature configured to provide haptic and audible feedback upon full seating of the doghouse fastener 106 within the doghouse structure 116, while also limiting lateral movement of the fastener relative to the structure. The click-in knuckle feature includes a recess 702 formed in one or both engagement structures 108 and a corresponding protrusion 704 formed on the stem 132 of the fastener portion 106b.

As the doghouse head 106a is advanced into the cavity 120, the protrusion 704 engages an edge of the engagement structure 108 and elastically deflects until it aligns with the recess 702. Once aligned, the protrusion 704 is received within the recess 702 in a detent-like manner, producing a perceptible “click” that indicates that the doghouse fastener 106 has reached a fully seated position. This interaction provides clear assembly confirmation and enhances consistency during installation.

In the assembled condition shown in FIGS. 8b, 8e, and 8f, the protrusion 704 remains seated within the recess 702, thereby inhibiting relative movement of the doghouse fastener 106 in directions transverse to the center axis 110, such as lateral or side-to-side movement. This stabilizing effect reduces potential vibration, noise, or misalignment between the doghouse fastener 106 and the doghouse structure 116 during use.

In contrast to the configuration shown in FIGS. 7a through 7f, the embodiment illustrated in FIGS. 8a through 8f omits the integral molded seal 706 to more clearly illustrate the structural and functional aspects of the fastener and click-in knuckle feature. However, it will be appreciated that an integral molded seal 706, as described above, may be included in the configuration of FIGS. 8a through 8f.

Accordingly, the configuration shown in FIGS. 8a through 8f maintains the primary retention and guided insertion provided by the outward-facing rails 124 and interior channels 114, while incorporating the click-in knuckle feature defined by the recess 702 and protrusion 704 to provide secondary retention, positional stability, and assembly verification in a manner consistent with, but optionally varied in geometry from, the example of FIGS. 7a through 7f, and with or without inclusion of the integral molded seal 706.

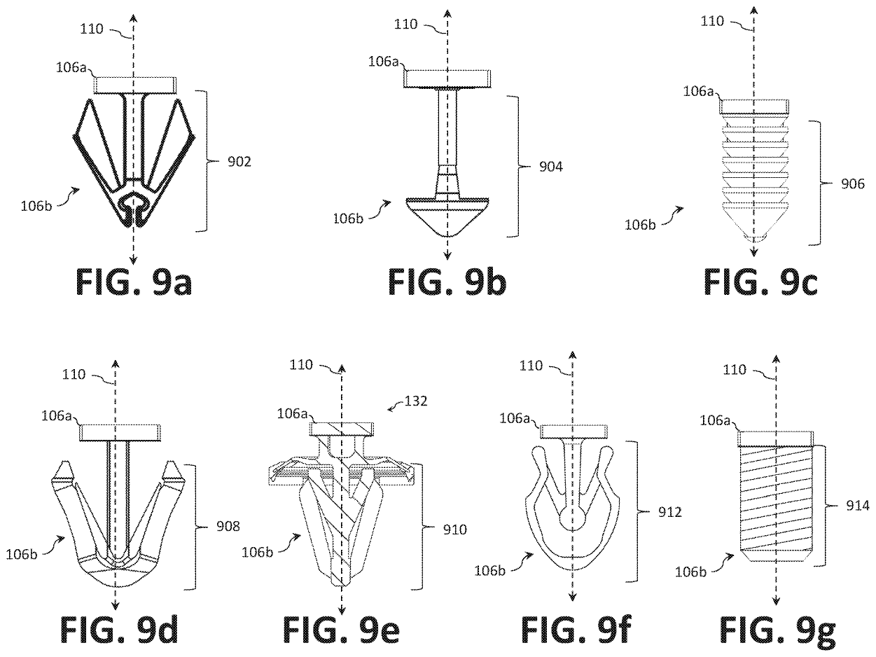

FIGS. 9a through 9g illustrate additional configurations of the doghouse fastener 106 for coupling with the second component 104 in accordance with further aspects of this disclosure. While the doghouse fastener 106 is illustrated in prior examples with a particular configuration of the fastener portion 106b, it will be appreciated that the fastener portion 106b may take a wide variety of forms depending on the desired attachment mechanism, installation requirements, and performance characteristics. In particular, FIGS. 9a through 9g illustrate, respectively, a W-shaped clip fastener 902 (illustrated as a two-legged clip configuration), a pin fastener 904, a push-pin fastener 906 (illustrated as a tree fastener), a specialty attachment assembly 908 (such as a CenterLok™-type fastener available from Deltar®), an attachment assembly with four retaining legs 910, an attachment assembly with two snap-engaging seats 912, and a threaded shank 914 (e.g., a threaded stud). Each of these configurations may be integrated with the doghouse head 106a and stem 132 to provide different modes of engagement with the opening 118 of the second component 104.

The attachment assembly with four retaining legs 910, illustrated in FIG. 9e as a cross-sectional view, may provide enhanced retention through multi-directional engagement and is further described in commonly owned U.S. Pat. No. 10,385,901 to Jeffrey J. Steltz. The attachment assembly with two snap-engaging seats 912 of FIG. 9f provides a snap-fit engagement and is further described in commonly owned U.S. Pat. No. 10,018,214 to Fulvio Pacifico Yon. These alternative fastener portion 106b configurations may be selected based on factors such as required retention force, serviceability (e.g., removability), alignment tolerance, packaging constraints, and material compatibility. Additional fastening approaches are also contemplated, including threaded fasteners, quarter-turn fasteners, bayonet-style connections, and other mechanical attachment mechanisms.

While the present method and/or system have been described with reference to certain examples, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular examples disclosed. Instead, the present method and/or system will include all examples falling within the scope of the appended claims, both literally and under the doctrine of equivalents.

What is claimed:

1. A fastening system comprising:
a doghouse structure associated with a first component, the doghouse structure defining a cavity and a pair of spaced-apart engagement structures, each engagement structure defining an interior channel facing the cavity; and
a doghouse fastener comprising a doghouse head and a fastener portion extending along a center axis,
wherein the doghouse head includes an outward-facing rail configured to be received within and translate along the interior channel during insertion of the doghouse head into the cavity along an insertion direction, and
wherein the outward-facing rail and the interior channel cooperatively define an interface that permits insertion of the doghouse head via sliding motion while resisting removal of the doghouse head from the cavity in a direction parallel to the center axis.

2. The fastening system of claim 1, wherein the interface defined by the outward-facing rail and the interior channel includes overlapping portions.

3. The fastening system of claim 1, wherein the outward-facing rail and the interior channel include at least one of a hook-shaped or an L-shaped sloped interfacing surfaces.

4. The fastening system of claim 3, wherein the outward-facing rail and the interior channel define substantially flat, angled surfaces.

5. The fastening system of claim 1, wherein the interface is configured such that a first force is required to insert the doghouse head into the cavity and a greater second force is required to remove the doghouse head from the cavity.

6. The fastening system of claim 1, wherein the doghouse structure further comprises at least one structural rib extending between at least one of the pair of spaced-apart engagement structures and the first component.

7. The fastening system of claim 1, wherein the doghouse structure further comprises at least one clip having a ramped surface configured to permit insertion of the doghouse head and a reverse-facing surface configured to resist removal of the doghouse head.

8. The fastening system of claim 1, wherein the doghouse structure further comprises a recess and the fastener portion includes a protrusion configured to be received within the recess to form a detent engagement.

9. The fastening system of claim 8, wherein the detent engagement is configured to provide at least one of audible or tactile feedback upon full insertion of the doghouse fastener into the doghouse structure.

10. The fastening system of claim 8, wherein the detent engagement inhibits movement of the doghouse fastener relative to the doghouse structure.

11. The fastening system of claim 1, wherein the outward-facing rail is positioned at an end of the doghouse head and oriented away from the doghouse structure.

12. The fastening system of claim 1, wherein the fastener portion includes a stem and at least one resilient wing configured to engage an opening in a second component.

13. A doghouse structure associated with a component, the doghouse structure comprising:
a body defining a cavity; and
a pair of spaced-apart engagement structures defining the cavity, each engagement structure including an interior channel facing the cavity,
wherein the interior channel is configured to receive an outward-facing rail of a mating fastener such that relative sliding insertion is permitted and removal along a central axis is resisted by an engagement between the interior channel and the outward-facing rail.

14. The doghouse structure of claim 13, wherein the interior channel includes at least one of a hook-shaped or an L-shaped profiles.

15. The doghouse structure of claim 13, wherein the interior channel includes a substantially flat, angled surface configured to form a ramped interface with the outward-facing rail.

16. The doghouse structure of claim 13, further comprising a recess formed in at least one of the engagement structures, the recess configured to receive a protrusion of a mating fastener to form a detent engagement.

17. The doghouse structure of claim 13, further comprising at least one structural rib coupled between at least one engagement structure and the component.

18. The doghouse structure of claim 13, further comprising at least one resilient clip configured to engage a mating fastener to resist withdrawal.

19. A doghouse fastener comprising:
a doghouse head; and
a fastener portion extending from the doghouse head along a center axis,
wherein the doghouse head includes an outward-facing rail configured to slidingly engage a corresponding interior channel of a doghouse structure during insertion, and
wherein the outward-facing rail is shaped to cooperate with the interior channel to resist removal of the doghouse head along the center axis.

20. The doghouse fastener of claim 19, wherein the outward-facing rail includes at least one of a hook-shaped or an L-shaped sloped profile.
